(19) United States
(12) Patent Application Publication
(10) Pub. No.: US 2011/0187575 A1
(43) Pub. Date: Aug. 4, 2011

(54) REMOTE CONTROL TRANSMITTER

(75) Inventor: TAKAYA NAKAMURA, Osaka (JP)

(73) Assignee: PANASONIC CORPORATION, Osaka (JP)

(21) Appl. No.: 13/019,468

(22) Filed: Feb. 2, 2011

(30) Foreign Application Priority Data
Feb. 4, 2010 (JP) 2010-022953

(51) Int. Cl. H04L 17/02

(52) U.S. Cl. 341/176

(57) ABSTRACT

A remote control transmitter of the present invention includes an electrostatic touch panel, a cover covering the electrostatic touch panel and having a fulcrum portion, and a wiring board having a switch contact and electrically connected to the electrostatic touch panel. Furthermore, the remote control transmitter includes a control unit for transmitting a remote control signal in response to an operation of the electrostatic touch panel or the switch contact. The cover is formed such that it is capable of carrying out rotational movement around the fulcrum portion, and the switch contact is pressed according to the rotational movement of the cover.

### BACKGROUND OF THE INVENTION

1. Field of the Invention

The present invention relates to a remote control transmitter used for remote operation of various electronic apparatuses.

2. Background Art

Recently, various electronic apparatuses such as televisions and disk players have been improved in the function. For remotely operating these various electronic apparatuses, remote control transmitters capable of carrying out reliable operation with a low cost have been demanded.

FIG. 8 is a partial sectional view showing a conventional remote control transmitter. FIG. 9 is an exploded perspective view showing a conventional remote control transmitter. Covers 2 made of insulating resin are placed respectively in two opening portions 1A of upper case 1 made of insulating resin such that they can move up and down.

Electrostatic touch panels 3 are placed on the bottom surfaces of covers 2, respectively. On the top surface, or top and bottom surfaces of each electrostatic touch panel 3, a plurality of electrodes are arranged in the orthogonal direction with a predetermined gap.

Operation body 4 is made of, for example, rubber. On the top surface of operation body 4, dome-shaped pressing sections 4A protruding upward are provided in two places. The top surface of pressing section 4A is brought into contact with the bottom surface of electrostatic touch panel 3.

On the top and bottom surfaces of wiring board 5, a plurality of wiring patterns (not shown) are formed. Switch contact 6 such as a push switch is mounted on the top surface of wiring board 5. Operation body 4 covers the top surface of wiring board 5, and switch contact 6 is contained in pressing section 4A.

Electrostatic touch panel 3 is connected to the wiring patterns on wiring board 5 via a plurality of flexible printed circuit boards 7, on which wiring patterns (not shown) are formed, and connectors 8.

Transmitting unit 9 such as an antenna for transmitting a remote control signal, and control unit 10 such as a micro computer are formed on wiring board 5. Electrostatic touch panel 3, switch contact 6, and transmitting unit 9 are connected to control unit 10 via the wiring patterns.

A battery (not shown) is contained in the bottom surface of lower case 11 which is made of insulating resin and which is provided with lid 12 made of insulating resin. Lower case 11 covers the bottom surface of upper case 1. Thus, remote control transmitter 15 is constructed.

FIG. 10 is a front view showing a conventional remote control transmitter and an electronic apparatus to be operated by using the remote control transmitter. On display screen 41 of electronic apparatus 40 such as a television to be remotely operated, a plurality of menus, for example, a plurality of keys 42 are displayed. In this state, when a user touches a predetermined place on the left side of the top surface of cover 2 of remote control transmitter 15 by, for example, a finger of the left hand, a part of electric charges of electrostatic touch panel 3 is transmitted to this finger, which changes the capacity of the place to be operated. Thereby, control unit 10 detects a place of electrostatic touch panel 3 on which the finger touches.

Control unit 10 transmits a remote control signal according to the place touched by the finger to electronic apparatus 40 from transmitting unit 9 as a radio wave. When electronic apparatus 40 receives the remote control signal, for example, a cursor of key 42A showing “A” displayed on display screen 41, which corresponds to the place touched by the finger, is displayed.

Furthermore, in this state, when the top surface of cover 2 is pressed, cover 2 and electrostatic touch panel 3 move downward, and pressing section 4A bends to carry out electric connection of switch contact 6. Control unit 10 detects this electric connection, and a remote control signal that is different from the above-mentioned signal is transmitted from transmitting unit 9 to electronic apparatus 40. Then, for example, “A” is displayed in input section 41A in the lower part of display screen 41, and the selection of a character is determined.

Furthermore, when a user touches another predetermined place on the right side of the top surface of cover 2 by a finger of the right hand, control unit 10 detects the touched place based on the change of the capacity of electrostatic touch panel 3. Then, a remote control signal is transmitted from transmitting unit 9 to electronic apparatus 40, and, for example, a cursor of key 42B showing “B” on display screen 41 is displayed. When the top surface of cover 2 is pressed with the state as it is, electric connection of switch contact 6 below it is carried out, and a remote control signal is transmitted. Then, a character “B” is displayed along with “A” in input section 41A.

At this time, when a user wishes to select a character of “N” or “H” instead of “B,” the user moves the finger rightward or upward in a state in which the finger touches the top surface of cover 2. Then, control unit 10 detects this touched place, and a remote control signal is transmitted to electronic apparatus 40. A cursor of a key “N” or “H” on display screen 41 is displayed. Thereafter, when the top surface of cover 2 is pressed, these characters are displayed in input section 41A.

That is to say, when a user puts a finger on the top surface of cover 2 of remote control transmitter 15 and moves the finger so as to touch a predetermined portion, a menu of characters displayed on display screen 41 is selected. Then, when the user presses the top surface of cover 2 to thus press switch contact 6 below it, determination, input, or the like, of a menu of characters or the like can be carried out by a remote operation.

When cover 2 is pressed as mentioned above as shown in FIG. 8, when a portion of the center of cover 2 shown by arrow A immediately above switch contact 6 is pressed, switch contact 6 is pressed perpendicularly to the bottom surface of electrostatic touch panel 3, and a pressing operation can be carried out reliably. However, as shown by arrow B, when an end portion of cover 2 is pressed, switch contact 6 is pressed obliquely in a state in which cover 2 tilts, thereby making the pressing operation unstable.

Therefore, actually, in addition to switch contact 6 below the center of cover 2, switch contacts 6 are provided in two to four places below the end portion of cover 2 for each cover 2. Thus, even when the end portion of cover 2 is pressed, cover 2 moves up and down in a parallel state. Thus, pressing operations of any of switch contacts 6 can be carried out reliably.

That is to say, in conventional remote control transmitter 15, many switch contacts 6 need to be provided below electrostatic touch panel 3, thus increasing the number of components.

### SUMMARY OF THE INVENTION

A remote control transmitter of the present invention includes an electrostatic touch panel, a cover covering the electrostatic touch panel and having a fulcrum portion, and a wiring board having a switch contact and electrically connected to the electrostatic touch panel. Furthermore, the remote control transmitter includes a control unit for transmitting a remote control signal in response to an operation of the electrostatic touch panel or the switch contact. The cover is formed such that it is capable of carrying out rotational movement around the fulcrum portion, and the switch contact is pressed according to the rotational movement of the cover.

### BRIEF DESCRIPTION OF THE DRAWINGS

FIG. 1 a partial sectional view showing a remote control transmitter in accordance with a first embodiment of the present invention.

FIG. 2 is an exploded perspective view showing the remote control transmitter in accordance with the first embodiment of the present invention.

FIG. 3A is a plan view showing an upper base material of an electrostatic touch panel used in the remote control transmitter in accordance with the first embodiment of the present invention.

FIG. 3B is a plan view showing a middle base material of the electrostatic touch panel used in the remote control transmitter in accordance with the first embodiment of the present invention.

FIG. 3C is a plan view showing a lower base material of the electrostatic touch panel used in the remote control transmitter in accordance with the first embodiment of the present invention.

FIG. 4 is a front view showing the remote control transmitter and an electronic apparatus to be operated thereby in accordance with the first embodiment of the present invention.

FIG. 5 is a partial sectional view showing a remote control transmitter in accordance with a second embodiment of the present invention.

FIG. 6 is an exploded perspective view showing the remote control transmitter in accordance with the second embodiment of the present invention.

FIG. 7 is a front view showing the remote control transmitter and an electronic apparatus to be operated thereby in accordance with the second embodiment of the present invention.

FIG. 8 is a partial sectional view showing a conventional remote control transmitter.

FIG. 9 is an exploded perspective view showing a conventional remote control transmitter.

FIG. 10 is a front view showing a conventional remote control transmitter and an electronic apparatus to be operated by using the remote control transmitter.

### DETAILED DESCRIPTION OF THE INVENTION

### First Embodiment

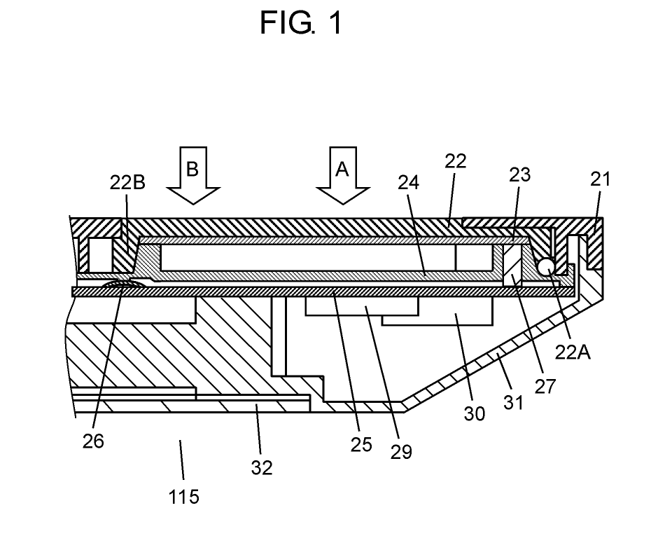

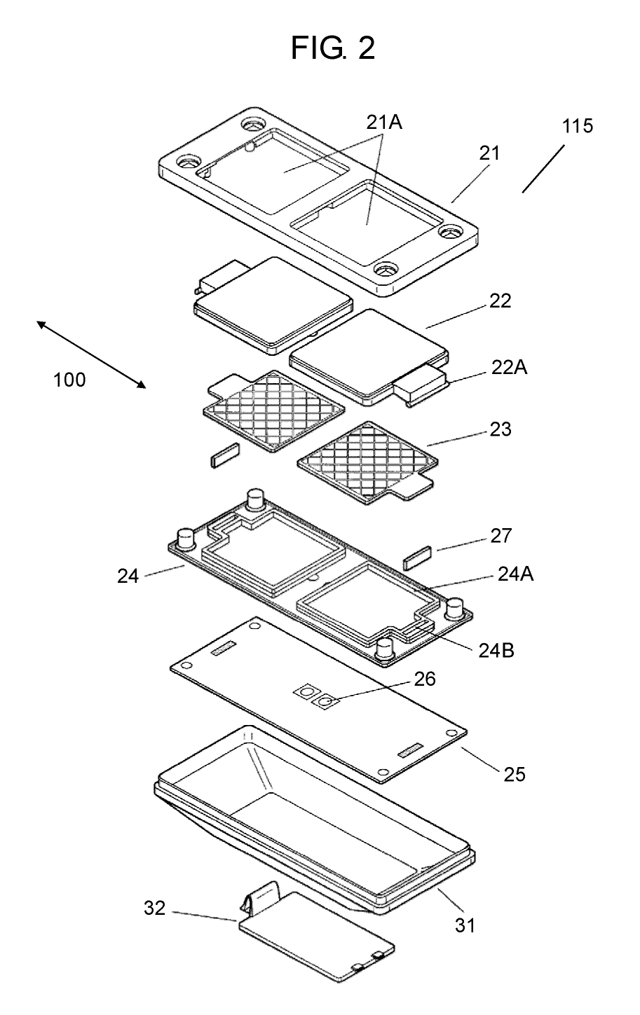

FIG. 1 a partial sectional view showing a remote control transmitter in accordance with a first embodiment of the present invention. FIG. 2 is an exploded perspective view showing the remote control transmitter in accordance with the first embodiment of the present invention.

Remote control transmitter 115 of the present invention includes electrostatic touch panel 23, cover 22 covering electrostatic touch panel 23, and wiring board 25 having switch contacts 26 and being electrically connected to electrostatic touch panel 23. Furthermore, remote control transmitter 115 includes control unit 30 for transmitting a remote control signal in response to an operation of electrostatic touch panel 23 or switch contacts 26.

Covers 22 made of insulating resin are placed in two opening portions 21A of upper case 21, respectively. Upper case 21 is made of insulating resin such as polystyrene or ABS.

Electrostatic touch panel 23 is placed on the bottom surface of cover 22. On one side of cover 22, cylindrical fulcrum portion 22A is provided.

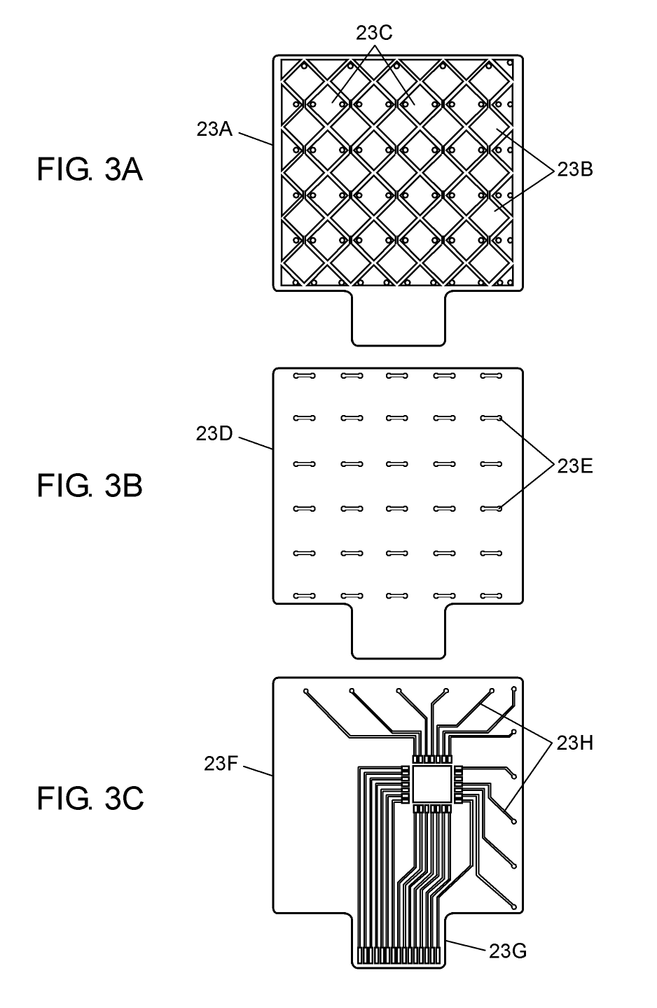

Herein, electrostatic touch panel 23 is described with reference to FIG. 3A to FIG. 3C. FIG. 3A is a plan view showing upper base material 23A of electrostatic touch panel 23. On the top surface of upper base material 23A such as glass epoxy, a plurality of square-shaped electrodes 23B are connected in a substantially band shape in the front-rear direction (the right and left direction in FIG. 1 and the direction shown by arrow 100 in FIG. 2). Electrode 23B is made of, for example, copper foil.

Furthermore, a plurality of square-shaped electrodes 23C are arranged in the right and left direction that is orthogonal to electrodes 23B. A plurality of electrodes 23C are not directly connected to each other.

FIG. 3B is a plan view showing middle base material 23D of electrostatic touch panel 23. On the top surface of middle base material 23D laminated on upper base material 23A, a plurality of connection patterns 23E of, for example, copper foil are arranged in the right and left direction.

The both ends of a plurality of connection patterns 23E are connected to electrode 23C via through holes (not shown) and the like filled with, for example, silver. Thus, a plurality of electrodes 23C are connected in a band shape in the right and left direction.

FIG. 3C is a plan view showing lower base material 23F of electrostatic touch panel 23. On the bottom surface of lower base material 23F laminated on middle base material 23D, a plurality of extraction patterns 23H of, for example, copper foil, are formed. One ends of extraction patterns 23H extend outward to extraction part 23G at the end portion of lower base material 23F. The other ends of the plurality of extraction patterns 23H are connected to the end portions of the plurality of electrode 23B and electrodes 23C via through holes and the like. With the above-mentioned configuration, electrostatic touch panel 23 is formed.

As shown in FIGS. 1 and 2, cover 22 and electrostatic touch panel 23 are mounted on frame-like frame portion 24A formed on the top surface of operation body 24. Operation body 24 is made of silicone rubber, elastomer, or the like. Dent-shaped holding section 24B is provided on the end portion of frame portion 24A. Fulcrum portion 22A of cover 22 is rotatably placed between holding section 24B and the bottom surface of upper case 21.

A plurality of wiring patterns (not shown) made of, for example, copper foil are formed on the top and bottom surfaces of wiring board 25. Wiring board 25 is made of paper phenol, glass epoxy, or the like. A fixed contact (not shown) made of, for example, carbon is provided in the center of the top surface of wiring board 25, and a dome-shaped movable contact made of, for example, a copper alloy is mounted thereon. Thus, switch contact 26 is formed.

Operation body 24 covers the top surface of wiring board 25. Pressing section 22B formed on the bottom surface of cover 22 is brought into contact with the top surface of operation body 24. The position, with which pressing section 22B is brought into contact, corresponds to a position above the center of switch contact 26.

Elastic connecting section 27 is placed between wiring board 25 and electrostatic touch panel 23 in the vicinity of fulcrum portion 22A in a state in which it is somewhat compressed vertically. Elastic connecting section 27 has a force for returning to an original state due to its elasticity. With this force, elastic connecting section 27 is held between wiring board 25 and electrostatic touch panel 23 and it is not easily separated therefrom. Elastic connecting section 27 is formed by arranging a conductive layer (not shown) in which, for example, carbon is dispersed in, for example, silicon rubber, and an insulating layer (not shown) made of, for example, silicone rubber alternately in the lateral direction at a predetermined interval.

The upper end of the conductive layer of elastic connecting section 27 is brought into contact with extraction part 23G (see FIG. 3C) of electrostatic touch panel 23. The lower end of the conductive layer of elastic connecting section 27 is brought into contact with the wiring pattern of wiring board 25. Thus, a plurality of electrodes 23B and electrodes 23C (see FIG. 3A) of electrostatic touch panel 23 are electrically connected to the wiring patterns at both ends of wiring board 25.

Transmitting unit 29 such as an antenna for transmitting a remote control signal, and control unit 30 such as a micro computer are formed on wiring board 25. Electrostatic touch panel 23, switch contact 26, and transmitting unit 29 are connected to control unit 30 via the wiring pattern.

A battery (not shown) is contained in the bottom surface of lower case 31 that is made of insulating resin such as polystyrene and ABS and is provided with lid 32 made of insulating resin. Lower case 31 covers the bottom surface of upper case 21, thus constructing transmitter 115.

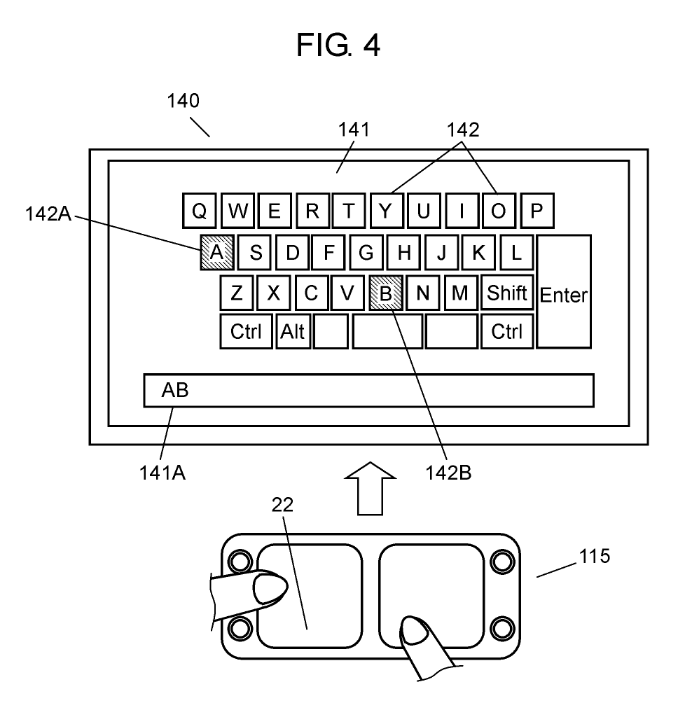

FIG. 4 is a front view showing a remote control transmitter and an electronic apparatus to be operated thereby in accordance with this embodiment. On display screen 141 of electronic apparatus 140 such as a television to be remotely operated, a plurality of menus, for example, a plurality of keys 142 are displayed. In this state, when a user touches a predetermined place on the left side of the top surface of cover 22 of remote control transmitter 115 by, for example, a finger of the left hand, a part of electric charges of electrostatic touch panel 23 is transmitted to this finger, which changes the capacity of the place to be operated. Thereby, control unit 30 detects a place of electrostatic touch panel 23 on which the finger touches.

Control unit 30 transmits a remote control signal (a first remote control signal) according to the place touched by the finger to electronic apparatus 140 from transmitting unit 29 as a radio wave. When electronic apparatus 140 receives this remote control signal, for example, a cursor of key 142A showing “A” displayed on display screen 141, which corresponds to the place touched by the finger, is displayed.

Furthermore, in this state, when the top surface of cover 22 is pressed, cover 22 and electrostatic touch panel 23 move rotationally downward around fulcrum portion 22A. Then, pressing section 22B of cover 22 presses the movable contact of switch contact 26 via operation body 24, thus carrying out electric connection of switch contact 26.

Then, control unit 30 detects electric connection of switch contact 26, and a remote control signal (second remote control signal) that is different from the above-mentioned signal is transmitted from transmitting unit 29 to electronic apparatus 140. Then, for example, “A” is displayed in input section 141A in the lower part of display screen 141, and the selection of characters is determined.

Furthermore, when a user touches another place on the right side of the top surface of cover 22 by a finger of the right hand, control unit 30 detects the touched place based on the change of the capacity of electrostatic touch panel 23. Then, a remote control signal is transmitted from transmitting unit 29 to electronic apparatus 140, and a cursor of key 142B showing “B” on display screen 141 is displayed. When the top surface of cover 22 is pressed with the state as it is, electric connection of switch contact 26 below it is carried out, and a remote control signal is transmitted. Then, the character “B” is displayed along with “A” in input section 141A.

At this time, when a user wishes to select a character of “N” or “H” instead of “B,” the user moves the finger rightward or upward in a state in which the finger touches the top surface of cover 22. Thus, control unit 30 detects this touched place, and a remote control signal is transmitted to electronic apparatus 140. A cursor of a key “N” or “H” on display screen 141 is displayed. Thereafter, when the top surface of cover 22 is pressed, these characters are displayed in input section 141A.

That is to say, when a user puts a finger on the top surface of cover 22 of remote control transmitter 115 and moves the finger so as to touch a predetermined portion, a menu of characters displayed on display screen 141 is selected. Then, when the user presses the top surface of cover 22 to thus press switch contact 26 below it, determination, input, or the like, of the menu of characters or the like can be carried out by a remote operation.

As mentioned above, when cover 22 is pressed, cover 22 rotationally moves around fulcrum portion 22A, and thus electric connection of switch contact 26 is carried out. Therefore, as shown in FIG. 1, in any of cases where a place shown by arrow A of the center of cover 22 is pressed, and where a portion shown by arrow B of the end portion is pressed, electric connection of switch contact 26 can be carried out reliably.

That is to say, since cover 22 on which electrostatic touch panel 23 is placed is formed such that it can rotationally move around fulcrum portion 22A. Therefore, regardless of the place of the top surface of cover 22 to be pressed, pressing section 22B usually presses switch contact 26 vertically. As a result, reliable electric connection can be carried out.

Therefore, it is not necessary to provide many switch contacts 26 below electrostatic touch panel 23. Remote control transmitter 115 can be formed by one switch contact 26 for each cover 22. Therefore, remote control transmitter 115 having a simple configuration can be provided at a low cost.

According to this embodiment, cover 22 is formed such that it can rotationally move around fulcrum portion 22A instead of moving up and down. Therefore, when it moves rotationally, elastic connecting section 27 is placed in the vicinity of fulcrum portion 22A in which movement of cover 22 is small, thus enabling electrostatic touch panel 23 to be connected to the wiring patterns of wiring board 25.

That is to say, a plurality of flexible printed circuit boards and connectors for connecting electrostatic touch panel 23 and wiring board 25 to each other are not needed. Electrostatic touch panel 23 can be connected to wiring board 25 with only elastic connecting section 27. Therefore, remote control transmitter 115 can be formed with a simple configuration and at a low cost.

In this embodiment, covers 22 and electrostatic touch panels 23 are placed in two opening portions 21A. However, the present invention is not limited to this configuration. One or three or more opening portions 21A, covers 22 and electrostatic touch panels 23 may be provided.

Furthermore, a cover having a protrusion may be provided below electrostatic touch panel 23 such that the protrusion presses switch contact 26. In this case, operation body 24 need not be provided.

Furthermore, in this embodiment, fulcrum portion 22A is provided on one side of cover 22. However, the present invention is not limited to this configuration, but fulcrum portion 22A may be provided in the middle part of the side of a cover.

### Second Embodiment

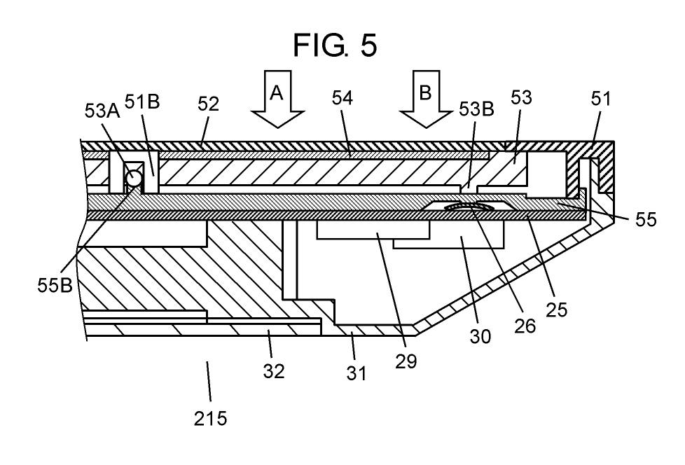

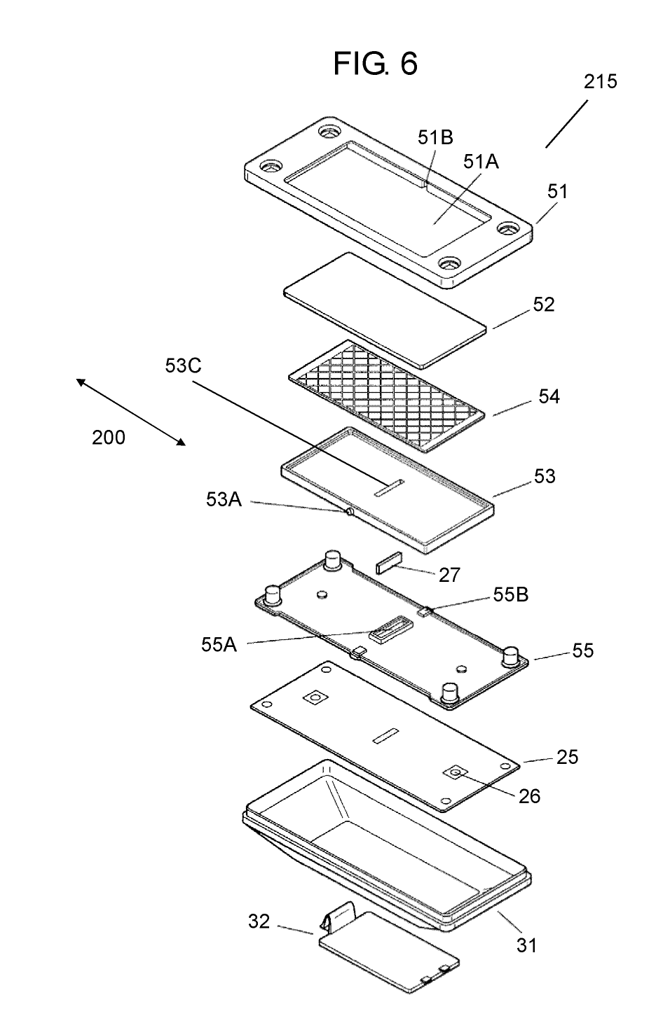

FIG. 5 is a partial sectional view showing a remote control transmitter in accordance with a second embodiment of the present invention. FIG. 6 is an exploded perspective view showing the remote control transmitter in accordance with the second embodiment of the present invention. Note here that the same numerals are given to the same components as those of the first embodiment, and the description thereof is omitted.

Remote control transmitter 215 includes upper cover 52 (first cover), lower cover 53 (second cover), and electrostatic touch panel 54 placed between upper cover 52 and lower cover 53. Furthermore, remote control transmitter 215 of the present invention includes wiring board 25 having switch contacts 26 and electrically connected to electrostatic touch panel 54. Furthermore, remote control transmitter 215 of the present invention includes operation body 55 disposed between lower cover 53 and wiring board 25 as well as control unit 30 electrically connected to wiring board 25.

Electrostatic touch panel 54 is contained between upper cover 52 and lower cover 53 which are made of insulating resin. That is to say, upper cover 52 (first cover) covers a first surface of the electrostatic touch panel, and lower cover 53 (second cover) covers a second surface opposite side to the first surface.

Upper cover 52 and lower cover 53 are placed in opening portion 51A of upper case 51 made of insulating resin. Cylindrical-shaped fulcrum portions 53A are provided in the middle portions of the both sides of lower cover 53.

Note here that a plurality of square-shaped electrodes 23B and electrodes 23C are arranged in the orthogonal direction, thus forming electrostatic touch panel 54. This is the same as panel 23 of the first embodiment shown in FIGS. 3A to 3C. However, in this embodiment, extraction part 23G to which a plurality of extraction patterns 23H extend is provided not in the end portion of lower base material 23F but in the vicinity of the center of lower base material 23F corresponding to the center of the bottom surface of electrostatic touch panel 54.

Through hole 55A is formed in the center of the top surface of operation body 55. Convex holding sections 55B are provided on the both sides in the center of operation body 55. Concave support sections 51B are provided on both sides in the center of upper case 51. Fulcrum portion 53A is rotatably placed between holding section 55B and support section 51B.

Operation body 55 covers the top surface of wiring board 25. Two switch contacts 26 are formed on the top surface of wiring board 25. Switch contacts 26 are formed on both sides of fulcrum portion 53A, that is, in the front-rear direction (in the direction shown by arrow 200 in FIG. 6) of fulcrum portion 53A, respectively. Pressing portion 53B is formed on the end portion in the front-rear direction of the bottom surface of the lower cover 53. The position of pressing portion 53B corresponds to a position above the middle between switch contacts 26. Therefore, pressing portion 53B can press switch contact 26 via operation body 55.

Elastic connecting section 27 is inserted into through hole 53C of lower cover 53 and through hole 55A of the center of operation body 55, and is placed between wiring board 25 and electrostatic touch panel 54 in a state in which it is somewhat compressed in the vertical direction. Elastic connecting section 27 has a force for returning to an original state due to its elasticity. With this force, elastic connecting section 27 is held between wiring board 25 and electrostatic touch panel 54 and it is not easily separated therefrom. A plurality of electrodes 23B and electrodes 23C of electrostatic touch panel 54 are electrically connected to a wiring pattern (not shown) in the center of wiring board 25 via elastic connecting section 27.

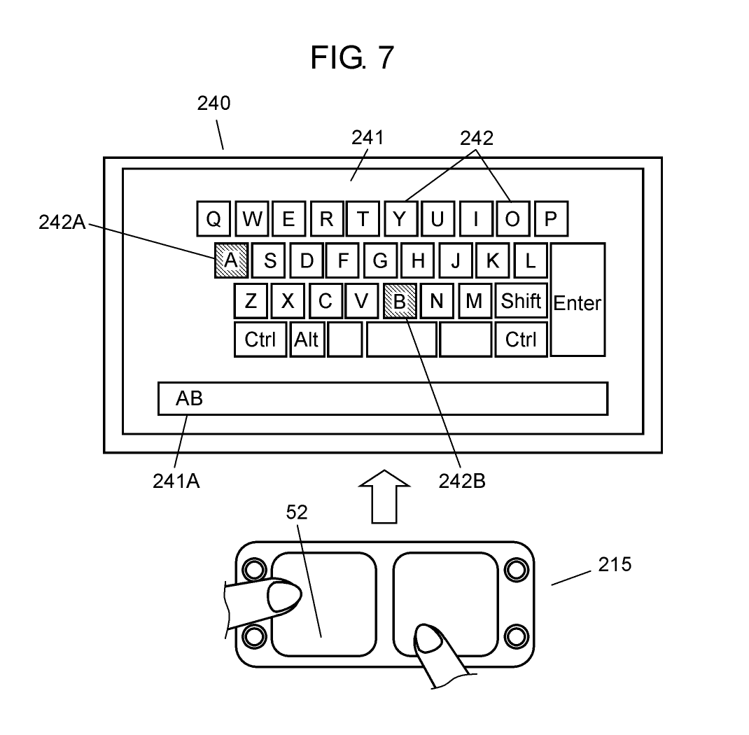

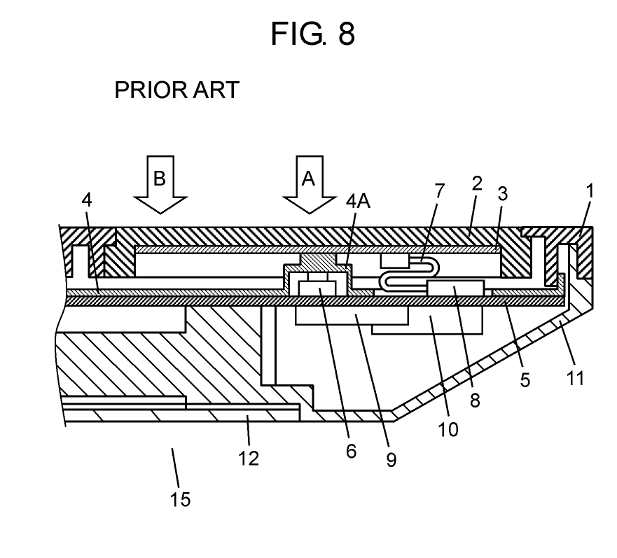

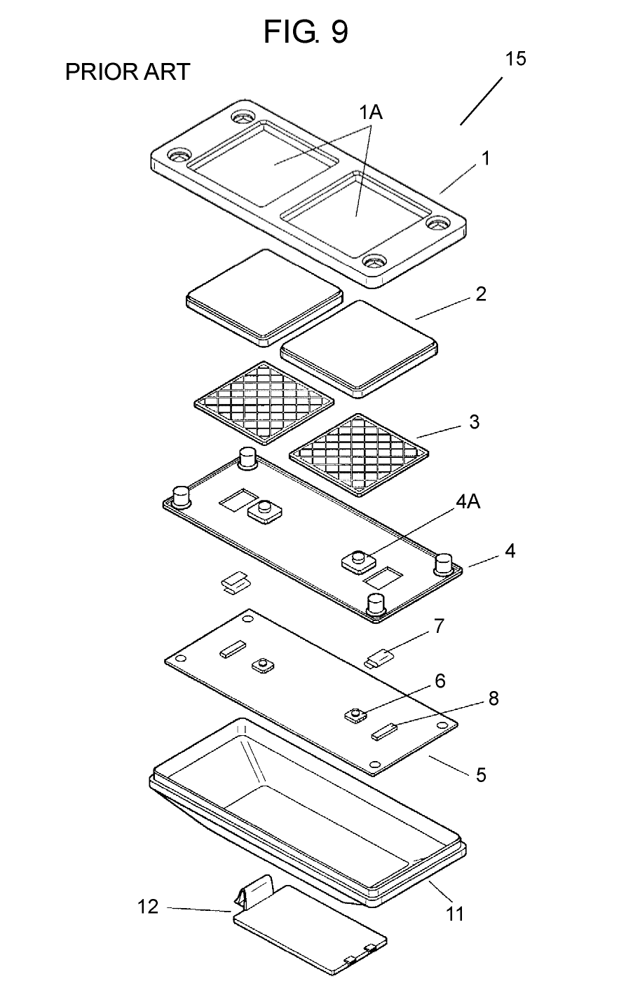

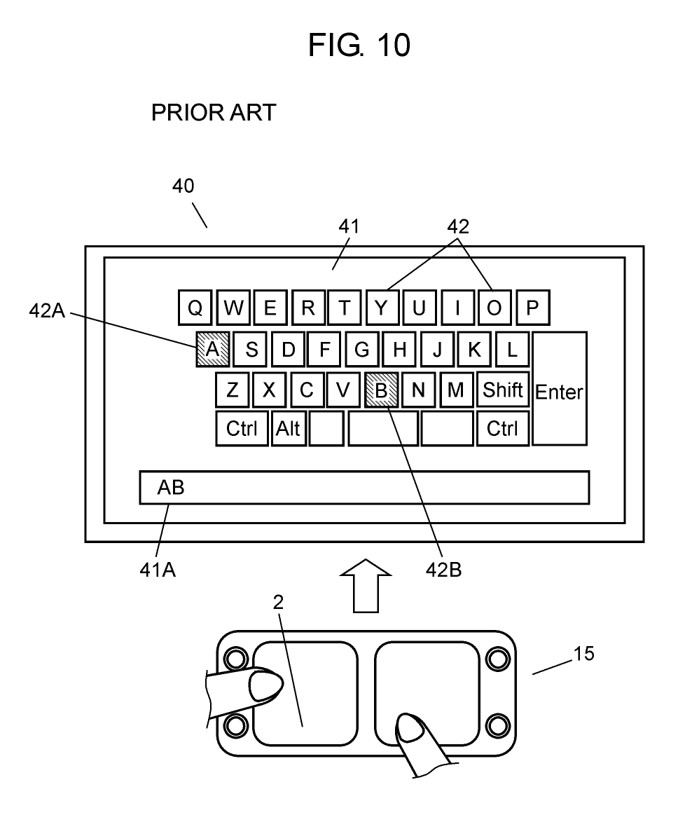

FIG. 7 is a front view showing a remote control transmitter and an electronic apparatus to be operated thereby in accordance with the second embodiment of the present invention. On display screen 241 of electronic apparatus 240 such as a television to be remotely operated, a plurality of menus, for example, a plurality of keys 242 are displayed. In this state, when a user touches a predetermined place on the right side of the top surface of upper cover 52 of remote control transmitter 215 by a finger, a part of electric charges of electrostatic touch panel 54 is transmitted to this finger, which changes the capacity of the place to be operated. Thus, control unit 30 detects a place of electrostatic touch panel 54 on which the finger touches.

Control unit 30 transmits a remote control signal according to the place touched by the finger to electronic apparatus 240 from transmitting unit 29 as a radio wave. When electronic apparatus 240 receives this remote control signal, for example, a cursor of a key of the selected character in keys 242 displayed on display screen 241 is displayed.

Furthermore, in this state, when the right side of the top surface of upper cover 52 is pressed, lower cover 53, upper cover 52 and electrostatic touch panel 54 rotationally moves around fulcrum portion 53A to the lower right part. Then, pressing section 53B of lower cover 53 presses switch contact 26 via operation body 55, thus carrying out electric connection of switch contact 26.

Then, control unit 30 detects the electric connection of switch contact 26, a remote control signal that is different from the above-mentioned signal is transmitted from transmitting unit 29 to electronic apparatus 240, and the selected character is displayed in, for example, input section 241A in the lower part of display screen 241. Thus, the selection of a character is determined.

Note here that also when a user touches the left side of the top surface of upper cover 52 by a finger, similarly, control unit 30 detects the touched place, and a remote control signal is transmitted from transmitting unit 29. Then, when the left side of the top surface of upper cover 52 is pressed, lower cover 53 and electrostatic touch panel 54 rotationally move around fulcrum portion 53A to the lower left part. The electric connection of switch contact 26 below it is carried out. Thus, a remote control signal is transmitted.

That is to say, when a user puts a finger on the top surface of upper cover 52 of remote control transmitter 215 and moves the finger so as to touch a predetermined portion, a menu of characters or the like displayed on display screen 241 is selected.

When the top surface of upper cover 52 is pressed, lower cover 53 and electrostatic touch panel 54 rotationally move around fulcrum portion 53A in the right and left direction, and switch contact 26 below operation body 55 is pressed. Thus, the determination, input, or the like, of the menu of characters is carried out by a remote operation.

As mentioned above, when upper cover 52 is pressed, lower cover 53 and electrostatic touch panel 54 rotationally move around fulcrum portion 53A, and electric connection of switch contact 26 is carried out. Therefore, as shown in FIG. 5, in any of cases where a place shown by arrow A near the center of upper cover 52 is pressed, and where a place shown by arrow B in the end portion is pressed, the electric connection of switch contact 26 can be carried out reliably.

That is to say, lower cover 53 to which electrostatic touch panel 54 is placed is formed such that it can rotationally move around fulcrum portion 53A. Therefore, regardless of the place of the top surface of upper cover 52, pressing section 53B of lower cover 53 always presses switch contact 26 perpendicularly. Thus, reliable electric connection can be carried out.

Therefore, it is not necessary to provide many switch contacts 26 below electrostatic touch panel 54. Remote control transmitter 215 can be formed by two switch contacts 26 provided on both ends of the top surface of wiring board 25. Therefore, remote control transmitter 215 can be formed with a simple configuration at a low cost.

Thus, according to this embodiment, upper cover 52 and lower cover 53 are formed such that they can rotatably move around fulcrum portion 53A instead of moving up and down in parallel. Elastic connecting section 27 is placed in the vicinity of fulcrum portion 53A in which upper cover 52 and lower cover 53 hardly move rotationally, that is, in the center of wiring board 25. In the rotational movement, electrostatic touch panel 54 is electrically connected to wiring patterns on wiring board 25.

That is to say, a plurality of flexible printed circuit boards, connectors, and the like, for connecting electrostatic touch panel 54 and wiring board 25 to each other are not needed, and electrostatic touch panel 54 can be connected to wiring board 25 only with elastic connecting section 27. Therefore, remote control transmitter 215 can be formed with a simple configuration and at a low cost.

In the above description, a configuration in which a dome-shaped movable contact is mounted on a fixed contact on the top surface of wiring board 25 to thus form switch contact 26 is described. However, a configuration may be employed, in which a push-button made of rubber and having a movable contact on the bottom surface thereof is formed above the fixed contact and is allowed to face the fixed contact. Alternately, the present invention can be carried out in a configuration using various switch contacts, for example, a configuration in which a single push-switch is mounted on the top surface of wiring board 25.

In this embodiment, upper cover 52, electrostatic touch panel 54 and lower cover 53 are placed on one opening portion 51A. However, the present invention is not limited to this configuration, but two or more of opening portions 51A, upper covers 52, electrostatic touch panels 54 and lower covers 53 may be provided, respectively.

Furthermore, in this embodiment, fulcrum portion 53A is provided in the middle portion of each of the both sides of lower cover 53. However, the present invention is not limited to this configuration, but fulcrum portion 53A may be provided in the end portion of the side of lower cover 53. In this case, elastic connecting section 27 is also disposed in the vicinity of fulcrum portion 53A.

As mentioned above, a remote control transmitter of the present invention can carry out electric connection reliably with a simple configuration and is useful mainly for remote operation of various electronic apparatuses.

What is claimed is:

1. A remote control transmitter, comprising:
an electrostatic touch panel;
a cover covering the electrostatic touch panel and having a fulcrum portion:
a wiring board having a switch contact and being electrically connected to the electrostatic touch panel; and
a control unit for transmitting a remote control signal in response to an operation of the electrostatic touch panel or the switch contact;
wherein the cover is formed such that it is capable of carrying out rotational movement around the fulcrum portion, and
the switch contact is pressed according to the rotational movement of the cover.

2. The remote control transmitter of claim 1,
wherein the fulcrum portion is formed on a side of the cover.

3. The remote control transmitter of claim 1,
wherein the fulcrum portion is formed in a middle portion of a side of the cover.

4. The remote control transmitter of claim 1,
wherein when the cover is touched, the control unit detects a touched place from the electrostatic touch panel and transmits a first remote control signal,
when the cover is pressed, the cover rotationally moves around the fulcrum portion, so that the switch contact is pressed, and the control unit transmits a second remote control signal.

5. The remote control transmitter of claim 1, further comprising:
an operation body disposed between the electrostatic touch panel and the wiring board,
when the cover is pressed, the operation body presses the switch contact.

6. The remote control transmitter of claim 1,
wherein the cover includes a first cover covering a first surface of the electrostatic touch panel, and a second cover covering a second surface opposite side to the first surface of the electrostatic touch panel, and
the fulcrum portion is formed on the second cover.
